(19) United States
(12) Patent Application Publication
(10) Pub. No.: US 2017/0308293 A1
(43) Pub. Date: Oct. 26, 2017

(54) SYSTEMS AND METHODS FOR DYNAMICALLY UPDATING VIRTUAL MOBILE KEYBOARDS

(71) Applicant: Kapps Media LLC, Marina Del Rey, CA (US)

(72) Inventors: Ray LEE, Los Angeles, CA (US); Vincent TUSCANO, New York, NY (US)

(21) Appl. No.: 15/493,717

(22) Filed: Apr. 21, 2017

Related U.S. Application Data
(60) Provisional application No. 62/327,260, filed on Apr. 25, 2016.

(51) Int. Cl. G06F 3/0488; G06F 3/0484

(52) U.S. Cl. CPC G06F 3/04886; G06F 3/04845; G06F 3/04847

(57) ABSTRACT

Methods and systems for dynamically updating a virtual keyboard implemented by an application running on a mobile device are provided. A first configuration file can be loaded that can have a default configuration of the virtual keyboard that displays design assets. A second configuration file can then be loaded with an updated configuration of the virtual keyboard with updated design assets. The methods and systems allow the generation of a design asset using the virtual keyboard

### Cross-Reference to Related Applications

This application claims priority under 35 U.S.C. §119(e) to U.S. Provisional Patent Application No. 62/327,260 filed on Apr. 25, 2016, and entitled “Systems and Methods for Dynamically Updating Virtual Mobile Keyboards,” the contents of which are hereby incorporated in their entirety by reference.

### FIELD OF THE INVENTION

The present invention relates to systems and methods for implementing virtual mobile keyboards, and specifically, the present invention relates to systems and methods for dynamically updating and customizing design assets on a virtual mobile keyboard.

### BACKGROUND OF THE INVENTION

Personal mobile electronic devices, such as smartphones and tablets, continue to improve becoming more sophisticated, while offering multiple applications that require interactions with the user. The available interfaces between the users and their devices, however, remain limiting. Traditionally, users of electronic devices provide textual input to computing devices by way of physical keyboards. Physical keyboards include physical buttons that each can correspond to different characters, such as letters, and functions, such as deleting characters. However, many types of modern computing devices, such as smartphones and tablets, do not have physical keyboards. Instead, these devices include touch-sensitive screens, e.g., a touchscreen, and implement “virtual” keyboards that can be displayed on the touchscreen. The virtual keyboard can include virtual keys that correspond to different characters and functions. Each of the virtual keys can correspond to a different area on the touchscreen.

Conventional virtual keywords typically allow a user to enter textual input to an application via the virtual keyboard. For example, a user can provide textual input to the device by tapping with a finger or a stylus on the virtual keys of a virtual keyboard displayed on the touchscreen. Thus, to input a word, the user can consecutively use the letters that make up the word. However, different applications, for example, email applications, social networking applications, and communication applications, running on a device allow a user to enter non-textual inputs, such as images, audio files, videos, GIFs, animations, stickers, memes. Some conventional virtual keyboards do not allow entering non-textual information, using the keyboard, and users need to open other applications to select the information they need to enter, e.g., a user may need to open an application storing images to select an image to enter in the application, e.g., an image that can be embedded in or attached to an email.

Other conventional virtual keyboards enable entering small digital images or icons (emoticons or emojis). However, these keyboards do not allow entering other rich-media format, such as video or audio. Moreover, these keyboards are relatively static and are not easily customizable.

Conventional ways for customizing mobile keyboards include enhancing the overall visual display of the keyboard by customizing colors, background images, or performing advanced key selection through a series of swiping gestures or long presses on a key. This can be done, for example, by downloading an application or “app” on a mobile device from an online app store or by updating an already downloaded application. Other conventional virtual keyboards that allow users to select stickers to send to another user can update the sticker selection of the keyboard, without downloading or updating the application. However, they do not allow customizing the sticker before sending it to the other user.

Accordingly, methods and systems for dynamically customizing stickers on a virtual mobile keyboard are desirable.

### SUMMARY

According to aspects of the disclosure, a method for dynamically updating a virtual keyboard can include the steps of providing on a mobile device an application that implements the virtual keyboard and loading a first configuration file corresponding to a first configuration of the virtual keyboard. The method can also include the steps of retrieving from a content delivery network a second configuration file corresponding to a second configuration of the virtual keyboard, when the application establishes a connection with the content delivery network, and configuring the virtual keyboard to render a design asset according to the second configuration.

According to aspects of the disclosure, the second configuration file is one of an entire configuration file and a partial configuration file containing updates to the first configuration file. According to aspects of the disclosure, the design asset can include at least one of an image, an audio playback, a video playback, and an animation and a content management system can build the second configuration from a plurality of design assets by performing at least one of dragging, dropping, uploading files, cropping, resizing, compressing, formatting image files, formatting video files, formatting audio files, sharing text, showing content, hiding content, and adding hyperlinks.

According to aspects of the disclosure, the method can further include the steps of selecting a size for the design asset, rendering the design asset according to the selected size to an area of the application other than the virtual keyboard, merging data from a first design asset with data from a second design asset to generate a third design asset, and rendering the third design asset.

According to aspects of the disclosure, the data from the first design asset comprises image data, the data from the second design asset comprises text data, and the third design asset is a rendering of a pixel composition of the image data and the test data, and the third design asset is rendered as a static design asset or as a non-static design asset. According to aspects of the disclosure, the method can further include the steps of providing at least one of a media or a hyperlink with the third design asset when the third design asset is rendered as a non-static design asset.

According to aspects of the disclosure, a system for dynamically updating a virtual keyboard can include a content delivery network and a mobile device in communication with the content delivery network configured to execute an application that implements the virtual keyboard, load a first configuration file corresponding to a first configuration of the virtual keyboard, retrieve from the content delivery network a second configuration file corresponding to a second configuration of the virtual keyboard, when the application establishes a connection with the content delivery network, and configure the virtual keyboard to render a design asset according to the second configuration.

According to aspects of the disclosure, the mobile device is further configured to select a size for the design asset, render the design asset according to the selected size to an area of the application other than the virtual keyboard, merge data from a first design asset with data from a second design asset to generate a third design asset, and render the third design asset. According to aspects of the disclosure, the mobile device is further configured to provide at least one of a media or a hyperlink with the third design asset when the third design asset is rendered as a non-static design asset.

### BRIEF DESCRIPTION OF THE DRAWINGS

FIG. 1 shows an exemplary method for loading content on a virtual keyboard, according to aspects of the invention.

FIG. 2 shows an exemplary content management system (CMS) for managing content used by a virtual keyboard, according to aspects of the invention.

FIG. 3 shows an exemplary method for managing a file system/storage used in connection with a virtual keyboard, according to aspects of the invention.

FIG. 4 shows an exemplary method for meme generation and sizing, according to aspects of the invention.

FIGS. 5a-5b show exemplary screenshots of a keyboard that enables adding electronic stickers, according to aspects of the invention.

FIGS. 6a-6b show exemplary screenshots of a keyboard that enables adding electronic audio files, according to aspects of the invention.

FIGS. 7a-7b show exemplary screenshots of a keyboard that enables adding electronic video files, according to aspects of the invention.

FIG. 8 shows an exemplary screenshot of a keyboard that enables adding electronic pictures, according to aspects of the invention.

FIGS. 9a-9f show exemplary screenshots of a keyboard that enables adding and customizing memes, according to aspects of the invention.

### DETAILED DESCRIPTION

The present invention is directed to systems and methods for implementing a virtual mobile keyboard. According to aspects of the disclosure, the methods and systems can dynamically customize a virtual keyboard implemented on the touchscreen of a mobile device, while the virtual keyboard is being used in connection with a particular application. The disclosed methods and systems can dynamically customize memes, publish digital stickers and multimedia within the integrated mobile keyboard application. The virtual keyboard can have multiple design assets, available to a user for selection. The keyboard can also group multiple design assets of the same type on a same view.

A person of ordinary skill would understand that the virtual mobile keyboard can be an object implemented within an application running on the mobile device. The content can be published, managed and edited through a mobile or web based content management system (CMS). The CMS can enable publishers of keyboards to modify or update design assets, such as characters, images, audio files, videos, GIFs, animations, stickers, memes, for example, by changing colors, logos and imagery, and provide analytics. All design assets can be managed with editable features, such as including add/delete features, re-ordering features, and auto-conversion features to shareable formats, such as images, audio, and video, in real-time. All updates of the design assets in the CMS can publish live on the user keyboard app.

According to aspects of the disclosure, the proposed systems and methods can enable a user to share stickers and multimedia to other users in certain applications that implement the disclosed virtual keyboard. The disclosed virtual keyboard can further enable a user to produce and share personalized messages on a selected visual template, e.g., a meme, directly from the keyboard application.

According to aspects of the disclosure, a disclosed virtual keyboard application can allow the publisher to associate a bitly Universal Resource Locator (URL) or a hyperlink to stickers or any media element through the CMS. The end-user of the virtual keyboard can copy, paste, or share the sticker or the media element carrying the associated link directly from the keyboard application. The bitly URL or the hyperlink can also be included with the design asset as it is shared from the keyboard app.

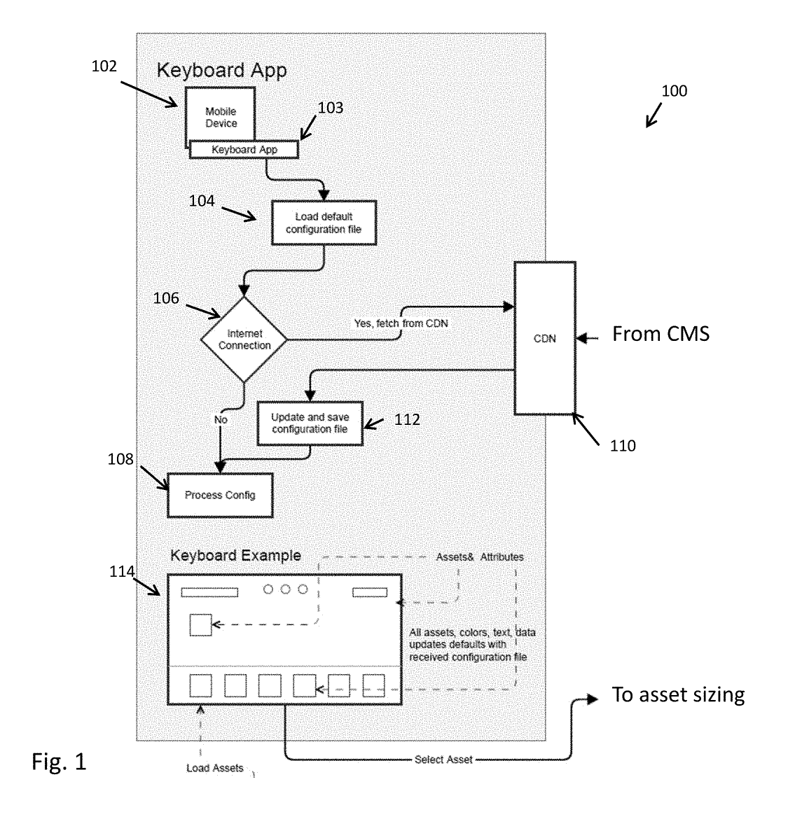

According to aspects of the disclosure, FIG. 1 shows an exemplary method 100 for loading content on a virtual keyboard, according to aspects of the invention. A user can operate a mobile device 102 that has an application 103 open that implements a virtual keyboard. The virtual keyboard can be loaded with a default configuration file 104. Once the default configuration file 104 is loaded, the method can check whether the mobile device is connected to the internet and whether the particular application 103 that implements the keyboard has permission to access the internet 106. If there is no available internet connection, then the method processes the default configuration file 108. If there is an available internet connection, then the method can fetch from a content delivery network (CDN) 110, such as Amazon's CloudFront and Simple Storage Service (S3), an updated configuration file. For example, the method make a request to the content delivery network 110 and can download the entire updated configuration file or a version that includes only the changes compared to the existing configuration file. The file can be for example, in the JSON (JavaScript Object Notation) format. Once the updated configuration file is fetched, it can be saved to the mobile device 112, and the updated configuration file can be processed 108. The mobile device can also compare the new configuration file with the existing configuration file and determine whether to keep or delete it. FIG. 1 also shows a virtual keyboard example 114. The virtual keyboard can load design assets and their associated attributes. According to aspects of the disclosure, the assets are rendered on the virtual keyboard according to the most recent configuration file saved in the mobile device.

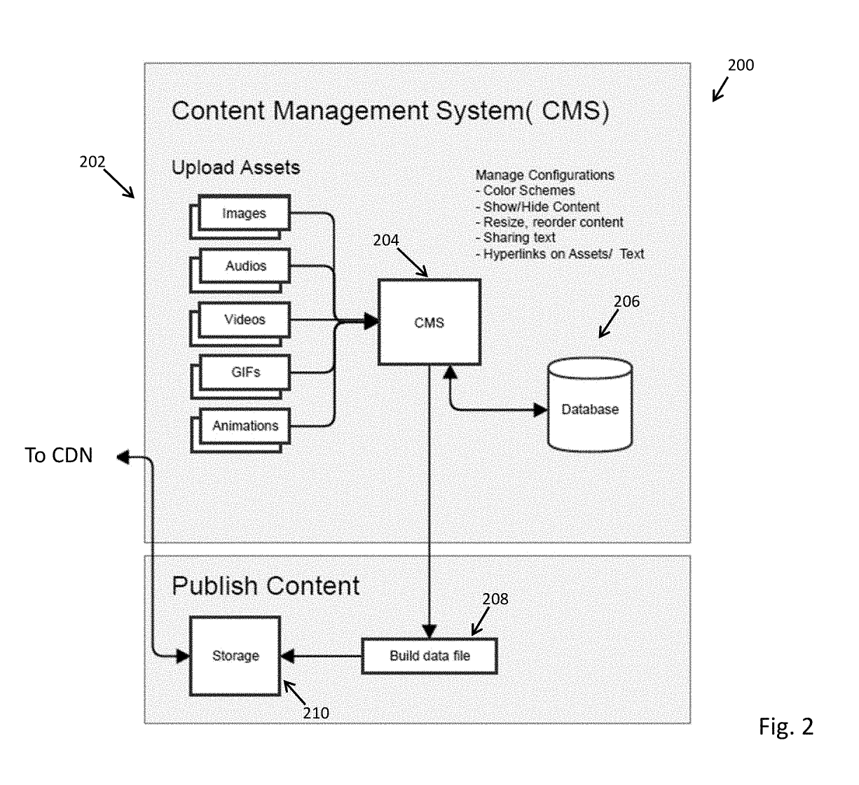

FIG. 2 shows an exemplary content management system (CMS) 200 for managing content, e.g., design assets, used by a virtual keyboard, according to aspects of the invention. The content can include images, audios, videos, GIFs, and animations 202. The content management system logic 204 can receive content and perform different configurations, for example, manage color schemes, show or hide content, resize or reorder content, allow sharing of text, and enable hyperlinks on assets or text. The content management system logic 204 can store the content into a database 206. All modifications made in the CMS or the database can generate a file or provide an API request for content. The content management system logic 204 can also provide the data for building a new configuration file 208. The new configuration file 208 can be stored locally at the CMS, for example, at storage 210, before it is sent to the CDN. The configuration can be stored in the CDN or storage 210 for quick replication and quick retrieval of compiled content. The configuration file can be received using a request, e.g., a Representational state transfer (REST) HTTP(S) request. The CMS can be a custom built proprietary framework for managing content, assets, and configurations. For example, it can include backend scripts that allow managing of content, such as, dragging and dropping, uploading files, automatically cropping, resizing, compressing, and formatting images, videos, gifs, and audio files. Audio and video scripts can convert files to the appropriate mediums as well as separate audio and/or video tracks. Video scripts can convert and compress content into animated gifs.

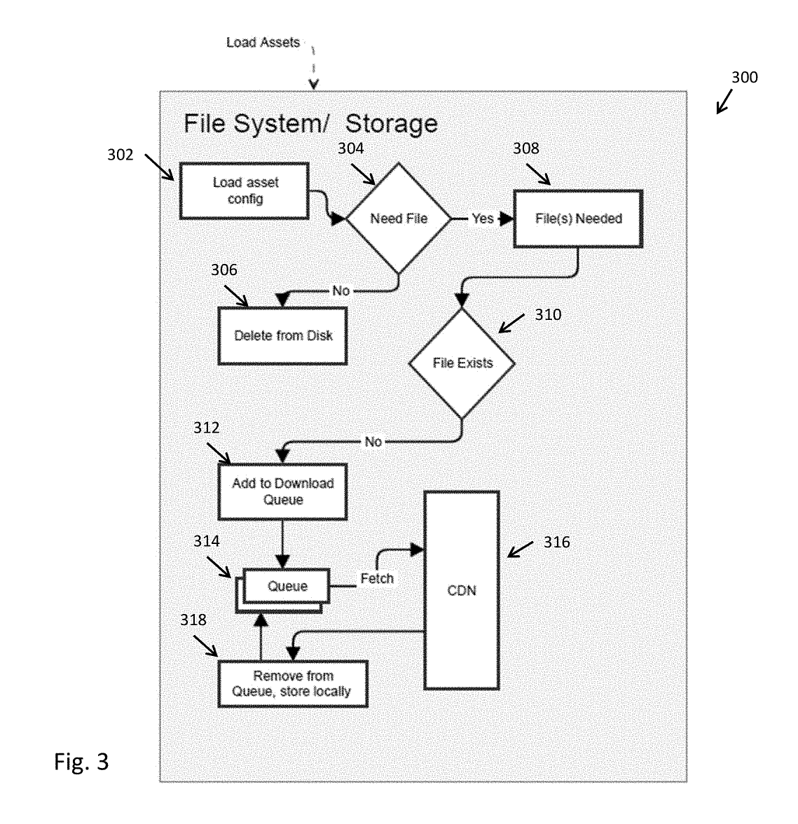

FIG. 3 shows an exemplary method for managing a file system/storage 300, which can be stored in the CDN, used in connection with a virtual keyboard, according to aspects of the invention. The method can first load an asset configuration 302. The method can receive a list of files, e.g., a configuration file or a design asset, for the particular asset configuration. The method can check whether a particular file, e.g., a configuration file or a design asset, is required 304. If the file is not required, it can be deleted from the disk 306. If the file is required, then the method checks whether the required file exists 310. If the file does not exist, then the file name is added to a download queue 312. When the file is downloaded, then the location of the file is added to the queue 314. If the file exists, the request to download the file can be removed from the queue. The files corresponding to the file requests stored in queue 314 can be fetched from CDN 316. Once a file is retrieved 318 from the CDN 316, the corresponding file request in the queue can be removed and the file can be saved locally.

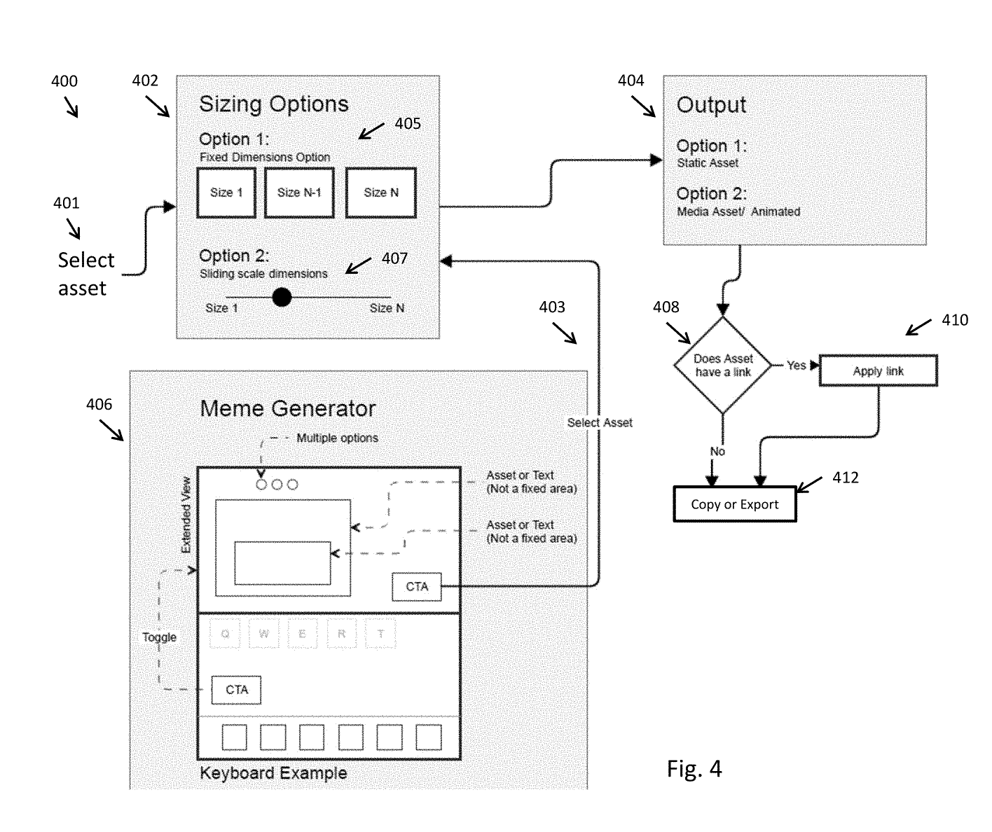

FIG. 4 shows an exemplary method 400 for resizing a design asset. The user can select an existing asset 401 or can select a meme 403 that was generated from meme generator 406. Memes generated according to the disclosed systems and methods can consist merging one assets' data with another asset's to generate a single entity (data asset). For example, when text is overlaid over an image, the disclosed system can render the union of a pixel composition or can overlay views and read the data from the containing view representing the overlay of objects. The method can provide different options for sizing the asset 402. For example, one option can allow a user to select a size among different fixed-size options 405. Another option can allow a user to select variable size option 407 to size the asset, e.g., using a sliding scale. The method then enables the user to select the way the asset will be output to the keyboard 404. For example, one option can be to output a static asset, e.g., an asset without any associated media or hyperlink. Another option can be to output a non-static asset, such as a media asset, an animated asset, or an asset with a hyperlink.

Once the type of the asset has been determined, the method can check whether the asset has an associated link 408. If the asset does not have a link, the method can copy or export the assert 412. If the asset includes a link, then the method can apply the link 410 and then copy or export the asset 412.

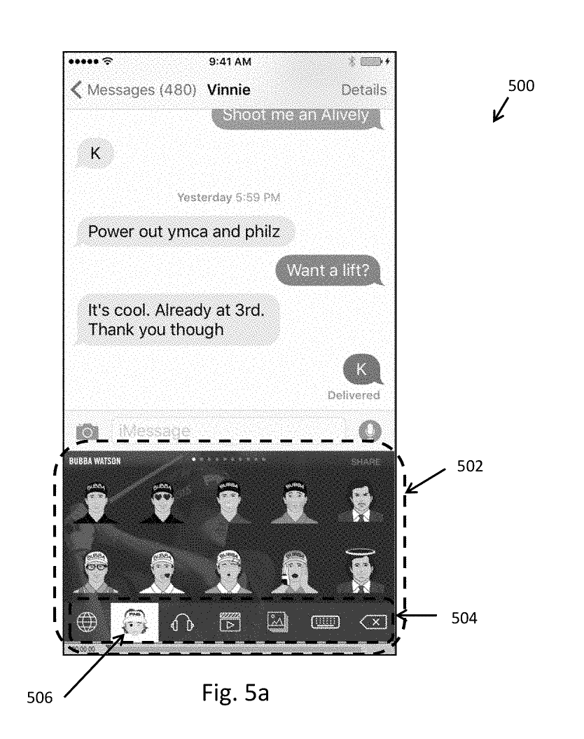

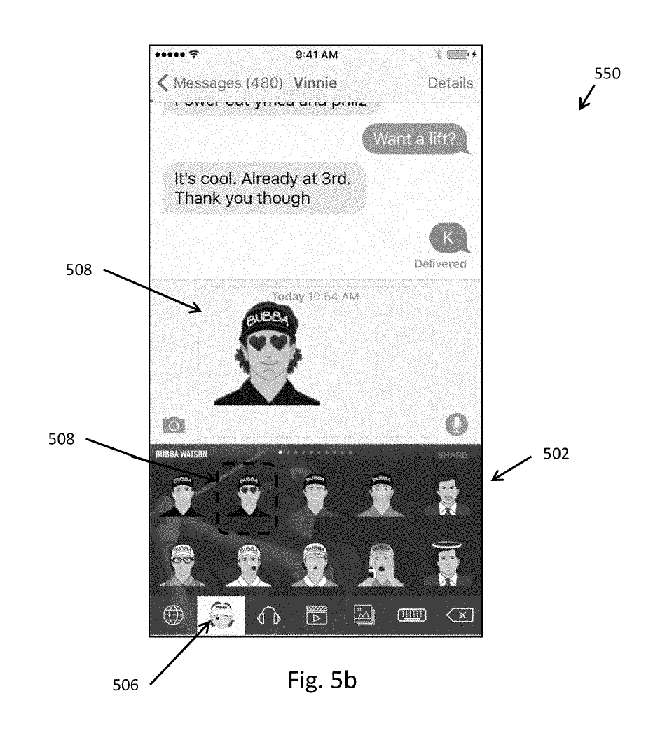

According to aspects of the disclosure, FIG. 5a shows an exemplary mobile device display screenshot 500 illustrating a keyboard 502 that enables adding electronic stickers, for example, in electronic messages. Keyboard 502 can have an area 504, that allows a user to select different types of design assets for entering, for example, when exchanging messages with another user. For example, keyboard 502 can provide a user the option 506 to select one or more stickers from a selection of stickers. When the user selects option 506, the keyboard can display different sticker options to the user.

FIG. 5b shows an exemplary mobile device display screenshot 550 after a user has selected sticker 508. Specifically, the selected sticker 508 can be previewed in a message drafting area 510, while a user is drafting his message.

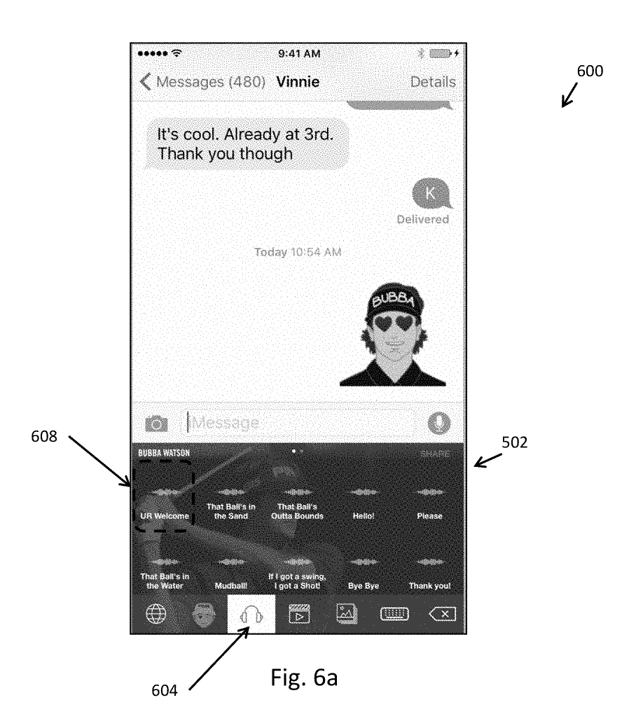

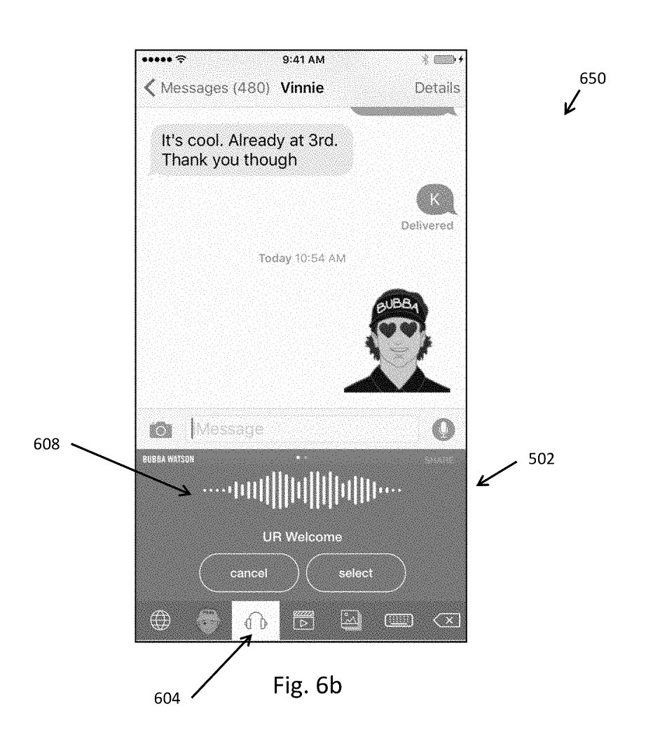

According to aspects of the disclosure, FIG. 6a shows an exemplary mobile device display screenshot 600 illustrating keyboard 502 that enables adding audio files, for example, in electronic messages. Keyboard 502 can provide a user the option 604 to select one or more electronic audio files from a selection of audio files. When the user selects option 604, the keyboard can display different audio file options to the user, e.g., audio file 608, entitled “UR Welcome.”

FIG. 6b shows an exemplary mobile device display screenshot 650 after a user has selected audio file 608. According to aspects of the disclosure, the virtual keyboard interface can be replaced by an interface that enables the user to preview the audio file, e.g., by playing the audio file, select the audio file for transmission, or cancel the selection of the audio file, e.g., as illustrated in FIG. 6b.

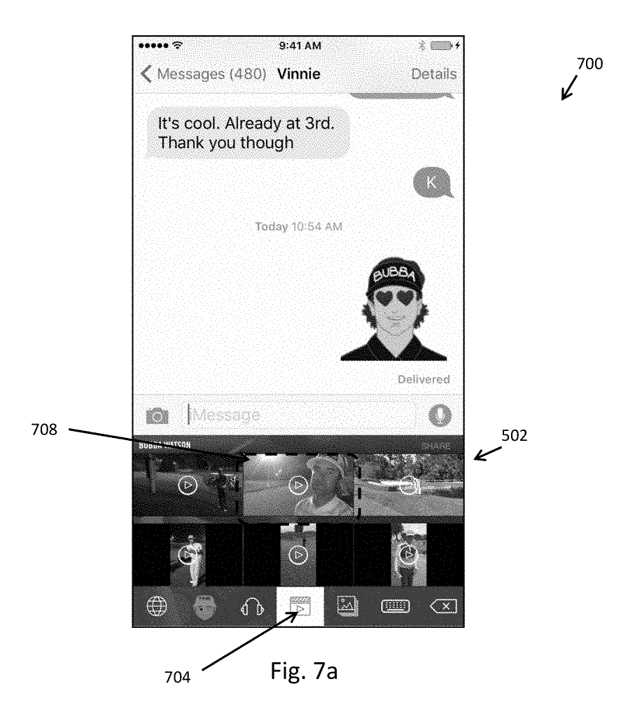

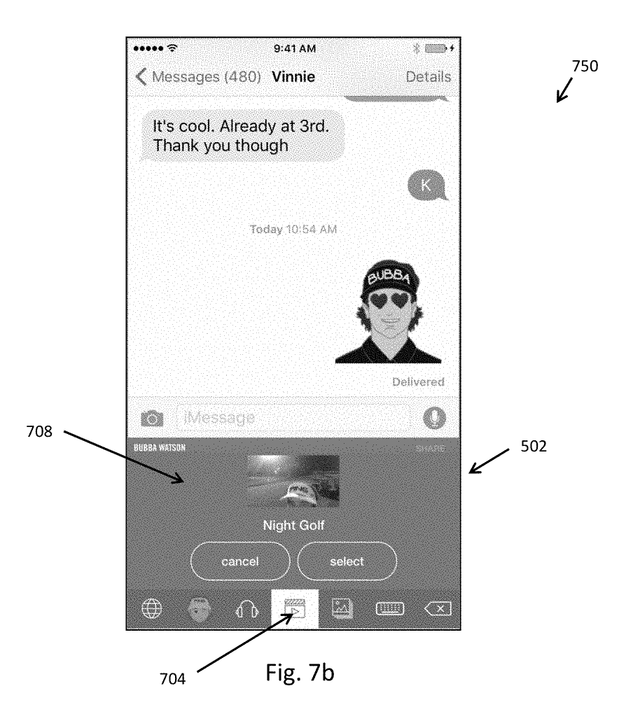

According to aspects of the disclosure, FIG. 7a shows an exemplary mobile device display screenshot 700 illustrating keyboard 502 that enables adding video files, for example, in electronic messages. Keyboard 502 can provide a user the option 704 to select one or more electronic video files from a selection of video files. When the user selects option 704, the keyboard can display different video file options to the user.

FIG. 7b shows an exemplary mobile device display screenshot 750 after a user has selected audio file 708. According to aspects of the disclosure, the virtual keyboard interface can be replaced by an interface that enables the user to preview the video file, select the video file for transmission, or cancel the selection of the video file, e.g., as illustrated in FIG. 7b.

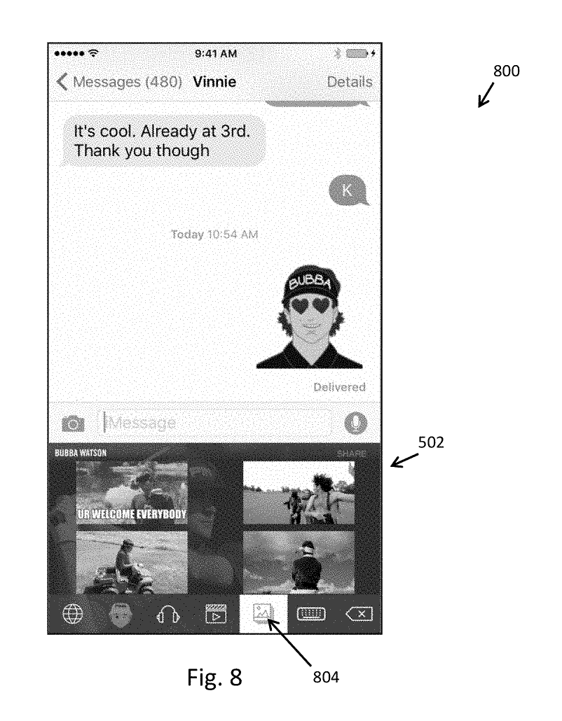

According to aspects of the disclosure, FIG. 8 shows an exemplary mobile device display screenshot 800 illustrating keyboard 502 that enables adding electronic images, for example, in electronic messages. Keyboard 502 can provide a user the option 804 to select one or more electronic images from a selection of images. When the user selects option 804, the keyboard can display different images to the user.

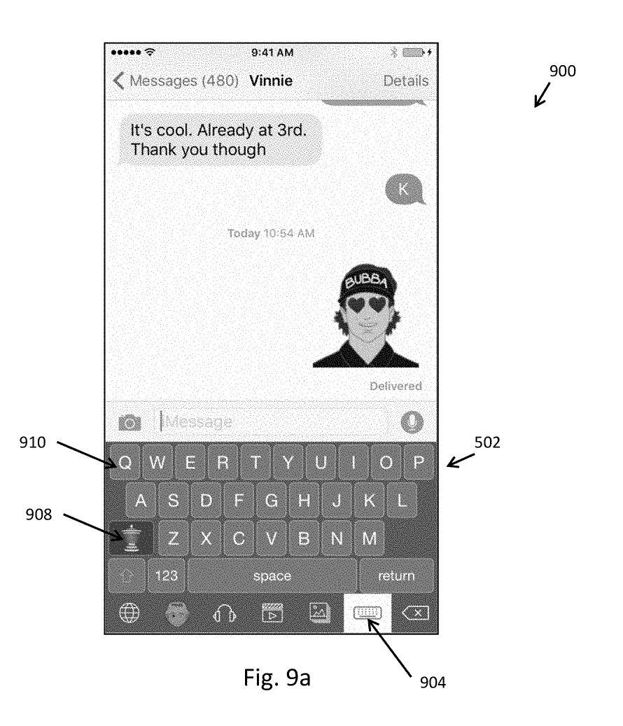

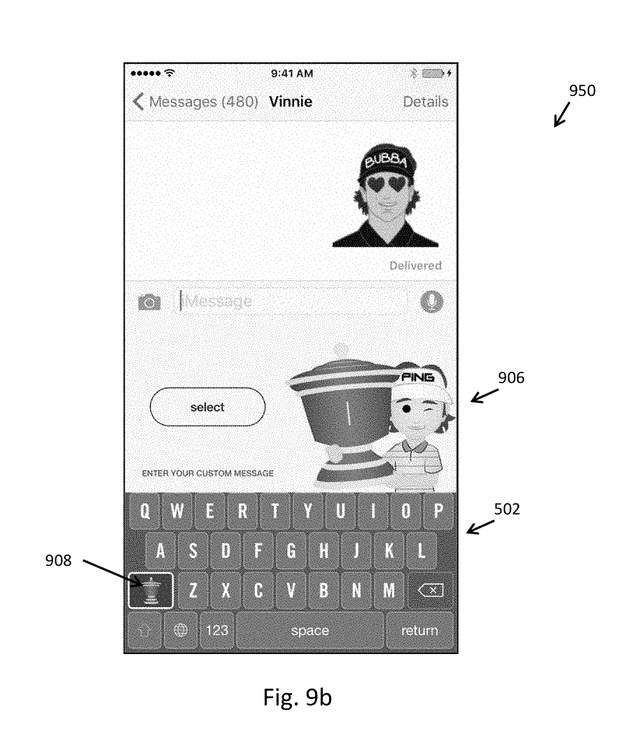

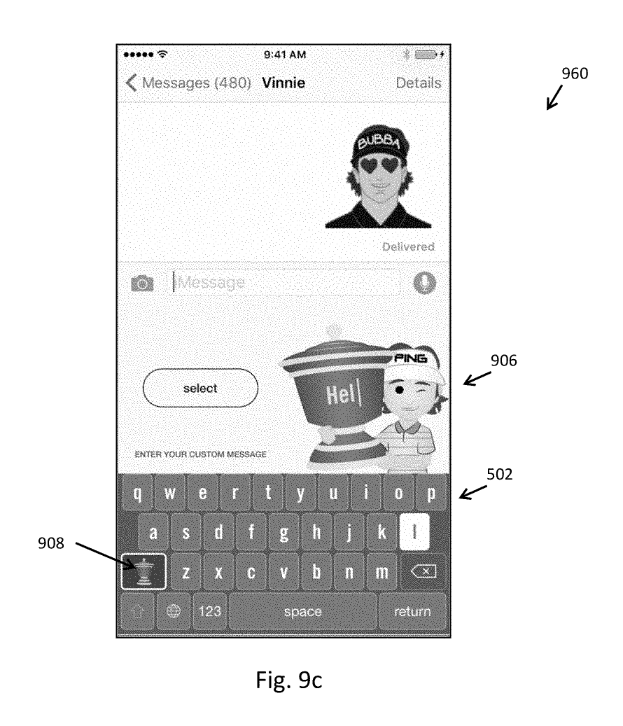

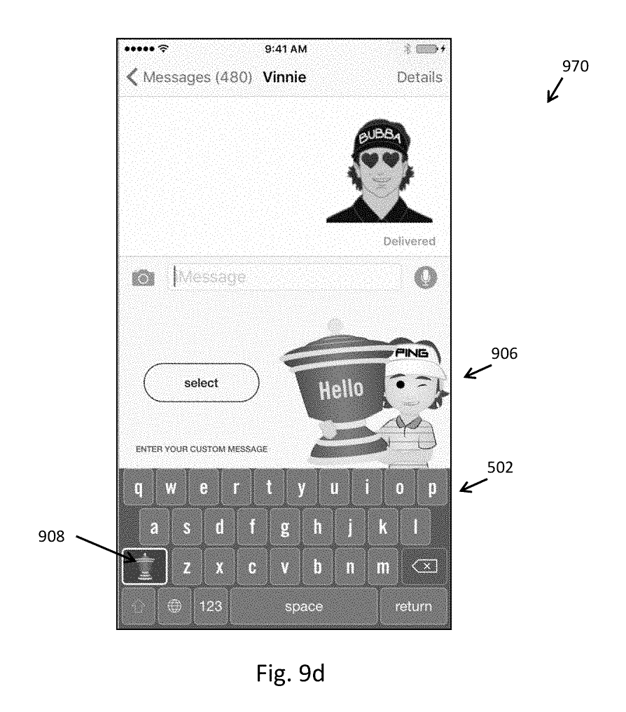

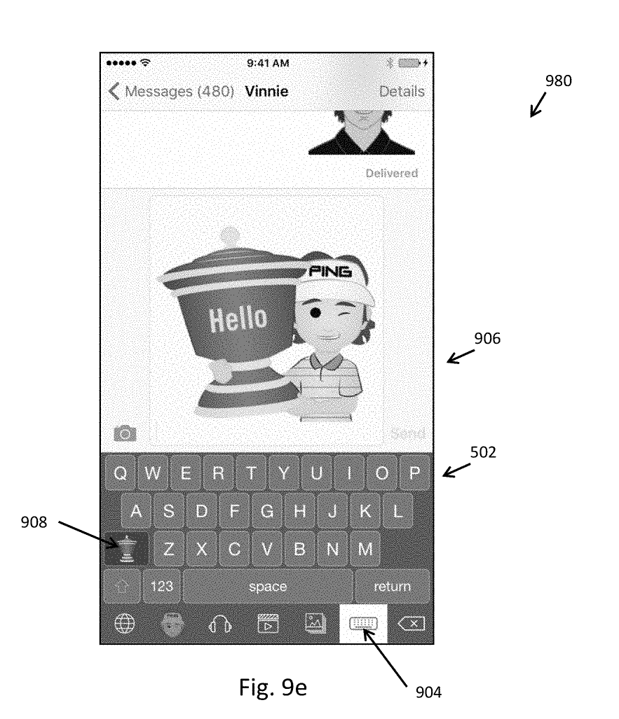

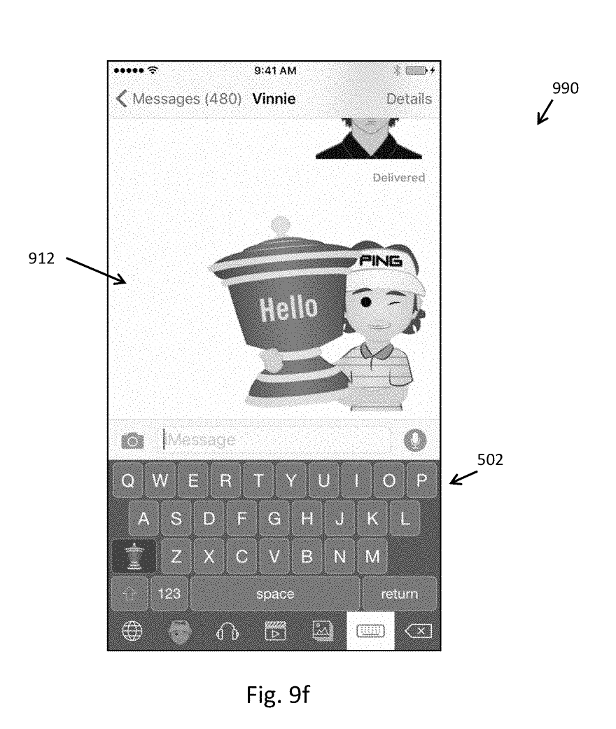

According to aspects of the disclosure, FIG. 9a shows an exemplary mobile device display screenshot 900 illustrating keyboard 502 that enables sending memes to another user, by customizing a design asset, e.g., a sticker. Keyboard 502 can provide a user the option 904 to select one or more design assets. When the user selects option 904, the keyboard can display different assets, e.g., stickers 908 and/or text characters 910.

FIG. 9b shows an exemplary mobile device display screenshot 950 after a user has selected sticker 908 to customize it into a meme. According to aspects of the disclosure, the selected sticker 908 can be previewed in a message drafting area 906, while a user is customizing it 906. For example, the user can add characters to the sticker to create a meme.

This is illustrated in FIG. 9c, which shows an exemplary mobile device display screenshot 960 after a user has started customizing the meme, e.g., by typing the word “Hello.” FIG. 9d, shows an exemplary mobile device display screenshot 970 after the user has finished customizing meme 906, and the whole word “Hello” has been added. The user can then select the meme and review the meme before sending it, as shown in FIG. 9e. After the user sends the meme, it can appear in the message exchange area of the mobile device display 912, as shown in FIG. 9f.

1. A method for dynamically updating a virtual keyboard comprising:
providing on a mobile device an application that implements the virtual keyboard;
loading a first configuration file corresponding to a first configuration of the virtual keyboard;
retrieving from a content delivery network a second configuration file corresponding to a second configuration of the virtual keyboard, when the application establishes a connection with the content delivery network; and
configuring the virtual keyboard to render a design asset according to the second configuration.

2. The method of claim 1, wherein the second configuration file is one of an entire configuration file and a partial configuration file containing updates to the first configuration file.

3. The method of claim 1, wherein the design asset can include at least one of an image, an audio playback, a video playback, and an animation.

4. The method of claim 1, wherein a content management system builds the second configuration from a plurality of design assets by performing at least one of dragging, dropping, uploading files, cropping, resizing, compressing, formatting image files, formatting video files, formatting audio files, sharing text, showing content, hiding content, and adding hyperlinks.

5. The method of claim 1, further comprising:
selecting a size for the design asset; and
rendering the design asset according to the selected size to an area of the application other than the virtual keyboard.

6. The method of claim 1, further comprising:
merging data from a first design asset with data from a second design asset to generate a third design asset; and
rendering the third design asset.

7. The method of claim 6, wherein the data from the first design asset comprises image data, the data from the second design asset comprises text data, and the third design asset is a rendering of a pixel composition of the image data and the test data.

8. The method of claim 6, wherein the third design asset is rendered as a static design asset or as a non-static design asset.

9. The method of claim 8, further comprising providing at least one of a media or a hyperlink with the third design asset when the third design asset is rendered as a non-static design asset.

10. The method of claim 6, further comprising:
selecting a size for the third design asset; and
rendering the third design asset according to the selected size to an area of the application other than the virtual keyboard.

11. A system for dynamically updating a virtual keyboard comprising:
a content delivery network; and
a mobile device in communication with the content delivery network configured to:
execute an application that implements the virtual keyboard;
load a first configuration file corresponding to a first configuration of the virtual keyboard;
retrieve from the content delivery network a second configuration file corresponding to a second configuration of the virtual keyboard, when the application establishes a connection with the content delivery network; and
configure the virtual keyboard to render a design asset according to the second configuration.

12. The system of claim 11, wherein the second configuration file is one of an entire configuration file and a partial configuration file containing updates to the first configuration file.

13. The system of claim 11, wherein the design asset can include at least one of an image, an audio playback, a video playback, and an animation.

14. The system of claim 11, further comprising a content management system configured to build the second configuration from a plurality of design assets by performing at least one of dragging, dropping, uploading files, cropping, resizing, compressing, formatting image files, formatting video files, formatting audio files, sharing text, showing content, hiding content, and adding hyperlinks.

15. The system of claim 11, wherein the mobile device is further configured to:
select a size for the design asset; and
render the design asset according to the selected size to an area of the application other than the virtual keyboard.

16. The system of claim 11, wherein the mobile device is further configured to:
merge data from a first design asset with data from a second design asset to generate a third design asset; and
render the third design asset.

17. The system of claim 16, wherein the data from the first design asset comprises image data, the data from the second design asset comprises text data, and the third design asset is a rendering of a pixel composition of the image data and the test data.

18. The system of claim 16, wherein the third design asset is rendered as a static design asset or as a non-static design asset.

19. The system of claim 18, wherein the mobile device is further configured to provide at least one of a media or a hyperlink with the third design asset when the third design asset is rendered as a non-static design asset.

20. The system of claim 16, wherein the mobile device is further configured to:
select a size for the third design asset; and
render the third design asset according to the selected size to an area of the application other than the virtual keyboard.
